(19) United States
(12) Patent Application Publication
(10) Pub. No.: US 2003/0223826 A1
(43) Pub. Date: Dec. 4, 2003

(54) Synthetic alternatives to uniform and non-uniform gradations of structural fill

(76) Inventor: Peter J. Ianniello, Havre De Grace, MD (US)

Correspondence Address: GARY L. SHAFFER, 901 BANKS PLACE, ALEXANDRIA, VA, 22312, US

(21) Appl. No.: 10/393,369

(22) Filed: Mar. 21, 2003

Related U.S. Application Data
(60) Provisional application No. 60/365,796, filed on Mar. 21, 2002.

(51) Int. Cl. E02D 3/00; C09K 17/00

(52) U.S. Cl. 405/302.4; 405/302.7

(57) ABSTRACT

Geostabilzing constructs made from synthetic materials such as recycled tires and plastic polymers are provided in forms engineered to stabilize large structures such as buildings, roadways, runways, parking lots, dams, levees and waste containment facilities. Methods and geostabilizers of the invention provide alternatives or complements to conventional uniform and non-uniform gradations of earthen materials thereby decreasing the amount of conventional materials needed to stabilize a large structure. Stabilizers of the invention impart superior resistance to compressive forces and can be designed and manufactured with to possess defined properties such as permeability to the flow of gases or liquids, compressibility, shear strength, rigidity, frictional coefficients, compactability, density, and resistance to movement. Embodiments of the present invention can be used in conjunction with various construction materials like pipe and culverts.

### RELATED APPLICATIONS

The present application claims the benefit of U.S. Provisional Application No. 60/365,796, filed Mar. 21, 2002.

### FIELD OF THE INVENTION

The present invention relates generally to engineered construction materials and methods that incorporate strips, sheets and other portions of synthetic polymer materials, or strips and other portions of tires, into planar elements, grids, lattices, solid and perforate sheet materials, and channeled drainage structures. Structures according to the invention improve the bearing capacities of soils upon which, or in which, they are positioned. The geo-stabilizing structures of the invention, or geostabilizers, can therefore be used in place of, or to complement, conventional engineered earthen materials such as non-uniform gradations of soil, gravel, concrete and stone.

### BACKGROUND OF THE INVENTION

The building of large structures such as landfills, foundations, roadways, runways, buildings, parking lots, retaining walls, embankments and the like often involves the excavation, re-contouring and other movement of large quantities of earthen materials such as soil, rock, earth, gravel, sand and the like. Earthen materials often must have defined physical, mechanical, and hydraulic properties in order to be selected for use in a design for a structure. Earthen materials are often used to provide drainage around foundations, as fill materials in retaining walls, landfill cap drainage soils, landfill leachate collection systems, landfill leachate detection systems, landfill gas venting systems, foundation drainage systems, and as fill material in roads and embankments. Earthen material drainage systems are constructed with respect to the vertical, diagonal, and horizontal aspects of a particular site in order to provide for gravity-based fluid transmission, that is, the drainage of aqueous and other fluids. Such gravity-based systems obviate the need and expense attendant to conveying fluid by mechanical means such as pumps. Typically, the weight of earthen materials, and the fact that the stones, sand and soil are typically not bound together, requires extensive subgrade preparation in order to create foundations sufficiently strong enough to support the static or dynamic weight of the structure. Thus, one purpose of such extensive subgrade preparation is to stabilize the earthen material and its drainage elements or systems in their desired position with respect to both the earth and to other parts of the structure with which the subgrade is associated.

For example, roadways, runways and parking lots usually have foundations comprising a base aggregate immediately under the paved surface, and a subgrade layer under the base aggregate which supports the weight of both of the overlying structures. Commonly, both the base aggregate and subgrade are formed of stones, soil and other earthen materials which have been transported to the site of the structure and subjected repeatedly to grading, tamping or other compressive operations and thereby formed into a foundation of desired elevation, inclination and direction. Buildings commonly have concrete foundations for their walls, or concrete slabs that support the weight of the overlying structure.

Conventional engineered earthen materials like sand, stone, or gravel are often selected as structural materials with non-uniform gradations. One purpose of this is to ensure proper drainage from the structure, and thus increase its useful life. Different types of soils that have uniform gradations can be engineered to transport fluids to collection systems like pipes. Typically, engineers also specify mixtures or combinations of various conventional earthen materials like sand, stone and gravel in order to obtain a non-uniform gradation and thereby control the transport of fluids in such a manner that the structure remains properly supported. One goal of engineered earthen systems of this nature is to lessen potential soil and stone particle movement when dynamic or static loads are applied, for example, in typical highway or road applications. Unwanted movement of soil and stone particles can result in the failure of the underlying materials to support the overlying burden of the structure and its traffic. It is thus important to control the movement of the materials underlying, and in the vicinity of, large structures and their foundations.

One way of controlling such movement is to require gradations of soil and stone that are easily compactable and have non-uniform gradations. The non-uniformity of the gradations of these materials is advantageous in that such materials have the tendency to fill in voids left behind by larger particles. Reinforcing products such as frameworks, which are integral to the materials underlying the foundation, or placed within it, also may be used to impede such undesired movement. Geosynthetic rolled good materials, such as geogrids and geotextiles, are often used to provide such a framework.

Earthen materials such as gravel and sand are used as fill, stabilization, and drainage materials on large man-made structures. In such uses, the purpose is to contain the surrounding earth and to drain it, for example, and to provide a strong foundation for the structure associated with the installation. Conventional earthen materials have a long track record and are commonplace in these applications. However, earthen materials often have shortcomings. For example, certain aggregates, like those of limestone, are not chemically compatible with fluids that have certain pH ranges. Exposure to fluids of such pH ranges causes rapid deterioration of the limestone, and the consequent deterioration of the installation. Other problematic aspects of earthen materials stem from the fact that certain types of sands may allow fluids to pass, but nonetheless retain relatively high moisture contents. Similarly, certain clays have great compressive strength under certain non-saturated moisture contents, but are relatively weak when fully saturated. Thus, conventional materials have significant problems in achieving structural goals.

To overcome some of these problems, manufacturers of earthen-engineered materials process stone, sand, and gravel in order to create processed or manufactured materials with defined physical, mechanical, and hydraulic properties. Earthen-engineered materials are created through such processes as quarrying, mining, washing, and sizing, for example, stone aggregate, in order to create materials with certain gradations and engineering properties for use in construction applications. This multibillion-dollar industry requires the standardization of significant material specifications. As a consequence, thousands of sites exist around North America to provide engineers and contractors with such specified materials. Often times, the earthen material specifications are defined by regional departments of transportation as well as Federal Highway Administration, and the American Association of Safety and Highway Transportation Officials.

These conventional processes and methods provide materials suitable for use within specific geographic markets. However, such conventional materials are neither easily nor inexpensively transportable. This is so chiefly because the availability of engineered earthen materials is determined largely by regional geological conditions. For example, stone quarries are rare in Florida. Typically, therefore, stone is quarried in Georgia and shipped to many Florida locations by rail. Unfortunately, many quarries are reaching the end of their useful lives, and the establishment of new quarries is often difficult or not economically feasible due to stringent environmental regulations.

These are some of the particular problems faced by waste impoundment facilities, FHWA, transportation departments, and many state, county and federal highway and transportation agencies. Thus, the economic challenges faced by engineers seeking suitable earthen materials such as soil, gravel, or stone having desirable engineering properties can be significant, depending on among other factors, the local geologic conditions and the costs of handling and transporting the materials to a work site. For instance, it is difficult to procure stone of consistent quality in many coastal areas. Thus, two of the key factors relating to the procurement costs and use feasibility of these conventional engineered earthen materials are availability and transportability.

Non-earthen materials such as geosynthetics have been used successfully as means for improving the engineering properties of earthen materials. Geosynthetic products are produced of polymer roll goods and are deployed on project sites in a manner that allows the materials to be unrolled and then sewn, tied, or welded together to thereby provide, for example, geosynthetic fabrics or laminates that are employed to improve the drainage characteristics of native earthen materials. However, conventional geotextiles have very little strength to resist the compressive forces that deform them. Instead, conventional geotextiles primarily exhibit tensile strength. Thus, under load, conventional geotextiles deform into the layers of soil above and beneath them such as the subgrade soil. Geogrids are similar to geotextiles in thickness but typically have a higher tensile modulus. Thus, both conventional geotextiles and conventional geogrids act to increase the cohesiveness of the subgrade or other layers associated with a large structure, such as a roadway, by resisting tensional forces and not by resisting compression.

One way of expressing the weakness of evaluating geotextiles and conventional geogrids with respect to compression is to recognize that they have little or no beam strength. This lack of beam strength is also a characteristic of most subgrades. Nonetheless, the conventional approach to strengthening subgrades does not recognize the importance of beam strength as an engineering parameter that can be important in the construction of large structures such as roadways. The strengthening of subgrades has heretofore been accomplished by applying significant quantities of earthen materials in layers over the subgrade. When conventional geogrids and geotextiles are used with earthen materials, the quantities of earthen materials required are related largely to the stabilizing effects of the tensile strength in the geogrid or geotextile under load. Thus, conventional fill materials are placed above the geogrids or geotextiles in sufficient quantities that the tensile strengths of the grids and textiles are mobilized sufficiently to resist continued subgrade deformation.

The subgrade of a large structure, such as a roadway, runway or building, is the layer of naturally occurring material upon which the structure is built. The strength of the subgrade must be sufficient to support the design load for that structure. Thus, in designing such structures, one requirement is to measure the resistance of the subgrade to deformation under the load that it is expected to sustain, for example, from vehicle wheels. If the inherent strength of the naturally occurring material is not sufficient to meet the design load requirements, then the subgrade must be modified or augmented sufficiently to meet them.

For instance, uniform and non-uniform gradations of conventional earthen and stone construction materials possess certain engineering properties such as density, compressibility, rigidity and compactability. Among other things, these properties confer upon the individual particles of soil, sand, stone and aggregates thereof, a certain resistance to movement when dynamic loadings are applied. However, difficulties commonly found in the use of conventional earthen materials include the expense of transporting and handling them, the loss of significant portions of their drainage capacities after they have been subjected to dynamic loadings over time, and the uncertainties in designing a particular installation, for example a roadway, with respect to its future exposure to the effects of weather, dynamic loading, and combinations thereof. Moreover, conventional earthen materials are commonly subject to reduction in their drainage capacities due to clogging when the reduced porosity impedes lateral movements of water and other fluids. Typically, conventional soils and aggregates are also selected because of their frictional characteristics.

U.S. Pat. No. 5,096,772 to Snyder, which is hereby incorporated by reference, discloses laminates of belted portions of scrap tires formed into slats, bars, mats, beams, and annular bodies. U.S. Pat. No. 6,258,193 to Coffin, which also is incorporated herein by reference, discloses methods for formulating laminates of portions of scrap tires into, for example, planks, posts and panels. The present means and methods adapt and modify synthetic materials such as tire strips into a myriad number of structures that are suitable for increasing the geo-structural stability of large structures such as buildings and roadways.

Thus there is a need for methods and materials to replace or complement conventional earthen materials and ways of stabilizing the subgrades under large structures in order to decrease the cost of using engineered earthen materials while sufficiently supporting traffic loadings and other compressive forces.

### SUMMARY OF THE INVENTION

Tires, portions thereof, and the structural elements of tires, have inherent properties such as tensile, flexural, dimensional and compressive strengths. Portions of tires formed into approximately planar configurations, such as sheets and strips, retain these properties. The present invention provides methods and synthetic constructs of tire portions that utilize strips of tires from the tread or other portions that are compressed in a manner that allows them to establish a certain desired planar stiffness or beam strength. Thus, because synthetic structures such as those made from plastic polymers or tire portions have beam strength, geostabilizers and methods according to the present invention are synthetic alternatives to conventional defined gradations of soils and aggregates that are typically used in many types of engineered geotechnical design applications such as the foundations of buildings and in the strata beneath roadways.

It is therefore an object of the invention to provide means and methods for stabilizing large structures such as roadways, runways, waste containment facilities which means and methods are an effective alternative or complement to the use of earthen materials.

It is another objective of the present invention to provide means and methods for reducing the amount of conventional earthen materials required to stabilize a large structure and to provide cost-effective alternatives to the use of engineered earthen materials.

It is also an object of the invention to provide types and categories of geostabilizers that are adaptable to stabilizing large structures such as buildings, building foundations, roadways, runways, parking lots, dams, levees, embankments, waste containment facilities and other large structures.

In accordance with these and other objects, a method is provided for reducing the quantity of earthen uniform and non-uniform gradations of structural fill needed to support a large structure. In general, the present method comprises the steps of processing synthetic materials into sheets or strips to form at least one geostabilizer of known dimensions, and then positioning the geostabilizer in relation to at least a portion of the subgrade of the large structure to thereby reduce the quantity of the uniform and non-uniform gradations of structural fill necessary to support that structure. The present means and methods are applicable or adaptable to many types of large structures, but are particularly advantageous in the design and construction of roadways, runways, parking lots, dams, levees, embankments, waste containment facilities and other large structures. Advantageous aspects of the invention are similarly suited to the design and construction of buildings, and particularly those buildings with slab foundations.

The present invention can be practiced with any material that is amenable to formation into a geostabilizing construct of a particular desired shape designed to fulfill the engineering requirements of a specified job or installation. Such materials especially include those that are moldable, extrudable or otherwise capable of formation into one or more of desired shapes. Preferable materials include synthetic materials such as new or recycled plastic polymers and those that are produced from used or new vehicle tires, and those materials used to produce vehicle tires and industrial belting.

In some preferred embodiments of the invention, the processing comprises the further step of sorting the synthetic materials, or portions thereof, such as chips, tiles, sheets or strips of tires or recycled plastics, into categories based upon their physical properties so that the materials may be selected according to the parameters of use and installation environment of one or both of the geostabilizer and the large structure. This selection is preferably made with respect to one or more physical properties selected from the group including shape, size, color, compressive strength, flexibility, beam strength, frictional characteristics, resistance to flow, porosity, permeability, rigidity, resistance to heat transfer or other insulation index, chemical compatibility, density, elasticity, compactability, compressibility, permeability to the flow of gases or liquids, tensile strength, resistance to chemical degradation, resistance to degradation by microbes, resistance to degradation by visible or non-visible light, resistance to degradation by nuclear radiation, and resistance to compression.

Geostabilizers of the invention can be of any shape, size, conformation and may possess any set of engineering characteristics desired or appropriate to a particular use or installation. In some preferred embodiments, the synthetic materials are processed into a geostabilizer comprising the shape of one or more from the group including sheets, strips, bars, discs, toruses, lattices, grids, woven grids, sheets, laminates of sheets or strips, annuli, beams, columns, spirals and combinations thereof. As a further advantage, geostabilizers according to the invention may be shaped, constructed, arranged or installed such that they may be connected to one another, anchored to one or more portions of the large structure or its subgrade, or to provide drainage for the large structure in which they are installed. Thus, in some preferred embodiments of the present methods and devices, the geostabilizer comprises one or more voids, or one or more types of voids, in the nature of one or more of perforations, apertures, slots, grooves, channels, corrugations, convolutions, recesses, sumps, notches, hollows, passages, ducts and combinations thereof. These voids may be of any size, shape, dimension or conformation and may be adapted to one or several functional uses in the invention.

Preferably, the voids are constructed and arranged to function as one or more of inter-strip or inter-sheet connectors, drainage passageways, sumps, connection holes for anchors, connection holes for inter-strip connectors and integration voids for retaining natural fill materials such as stone, sand, soil and aggregate mixtures. In those embodiments having integration voids, these may be employed to act as anchoring or positioning elements in relation to one or more segments or portions of the large structure. This aspect of the invention is particularly useful when the large structure comprises one or more of sand, soil, natural aggregates, synthetic aggregates, synthetic geonets and synthetic geocomposites.

Preferably, and for reasons of economy and efficiency, the positioning of the geostabilizer in relation to one or more portions of the particular subgrade is performed during the construction or assembling of the large structure. According to the present means and methods, geostabilizers according to the invention may be positioned or installed in any location relative to the subgrade so long as the desired improvements in structural performance are achieved. Some preferable positions include wherein the geostabilizer is positioned in relation to the large structure, for example, in relation to a roadway, runway or building foundation, in one or more positions from the group including above or below the subgrade, between earthen or aggregate layers, above or below earthen or aggregate layers, above bedrock, or adjacent to a concrete foundation of the roadway, runway or foundation.

In an additional aspect, the methods of the present invention encompass the advantage of pre-specification, that is, in some preferred embodiments, a particular installation is designed in advance of construction of the large structure, and with respect to the characteristics of a particular subgrade. Thus, geostabilizers according to the invention may be constructed and arranged such that the one or more selected portions of the large structure are stabilized in accordance with one or more pre-specified engineering parameters. Any engineering parameter or value, or groups thereof, may be used to arrive at desired specifications for geostabilizers for use in the methods according to the invention. Preferably, the pre-specified engineering parameters are one or more chosen from the group including the CBR, frictional characteristics, resistance to flow, porosity, permeability, rigidity, resistance to heat transfer or other insulation index, density, soil cohesiveness, compactability, permeability to the flow of gases or liquids, and resistance to compression.

One preferred embodiment of the inventions utilizes the CBR test as a pre-specified engineering parameter to evaluate a subgrade to the extent necessary to provide design parameters of a particular geostabilizer or set of geostabilizers. Thus, for example, using results from the CBR test of one or multiple samples of the subgrade or other relevant layer, a geostabilizer is constructed and arranged with respect to the subgrade such that, with use of the stabilizer, the CBR values improve to a desired performance level. Preferably, the improvement is at least 3%, at least 6%, at least 9%, at least 15% or at least 20% over that of the unmodified subgrade.

In accordance with yet other objects of the invention, numerous permutations of geostabilizers are provided. In one aspect, a geostabilizer of the invention comprises one or more sheets or strips formed from synthetic materials wherein the sheets or strips are provided in known dimensions and categories based upon their physical properties. Preferably, the physical properties are selected according to the types of use and installation of the sheets or strips in relation to the large structure such that positioning the geostabilizer in relation to at least a portion of the subgrade of the large structure results in a reduction of the quantity of uniform and non-uniform gradations of structural fill necessary to support the large structure.

In some preferred embodiments of the invention, the processing of the synthetic materials includes the step of sorting the synthetic materials, or portions of them, such as chips, tiles, sheets or strips of tires or recycled plastics, into categories based upon their physical properties so that the materials may be selected according to the parameters of use and installation environment of one or both of the geostabilizer and the large structure. This selection is preferably made with respect to one or more physical properties selected from the group including shape, size, color, compressive strength, flexibility, beam strength, frictional characteristics, resistance to flow, porosity, permeability, rigidity, resistance to heat transfer or other insulation index, chemical compatibility, density, elasticity, compactability, compressibility, permeability to the flow of gases or liquids, tensile strength, resistance to chemical degradation, resistance to degradation by microbes, resistance to degradation by visible or non-visible light, resistance to degradation by nuclear radiation, and resistance to compression.

Preferable synthetic materials are one or more of those selected from the group including used, recycled or new vehicle tires, new or used industrial belting, and new or recycled plastic polymers. Geostabilizers of the invention can be of any shape, size or conformation and may possess any set of engineering characteristics desired or appropriate to a particular use or installation. In some preferred embodiments, the synthetic materials are processed into one or more geostabilizers comprising the shape of one or more from the group including sheets, strips, bars, discs, toruses, lattices, grids, woven grids, sheets, laminates of sheets or strips, annuli, beams, columns, spirals and combinations thereof.

As a further advantage, geostabilizers according to the invention may be shaped, constructed, arranged or installed such that they may be connected to one another, anchored to one or more portions of the large structure or its subgrade, or to provide drainage for the large structure in which they are installed. Thus, in some preferred embodiments of the present methods and devices, one or more geostabilizers comprise one or more voids, or one or more types of voids, in the nature of one or more of perforations, apertures, slots, grooves, channels, corrugations, convolutions, recesses, sumps, notches, hollows, passages, ducts and combinations thereof. These voids may be of any size, shape, dimension or conformation and may be adapted to one or several functional uses in the invention.

Preferably, the voids are constructed and arranged to function as one or more of inter-strip or inter-sheet connectors, drainage passageways, sumps, connection holes for anchors, connection holes for inter-strip connectors and integration voids for retaining natural fill materials such as stone, sand, soil and aggregate mixtures. In those embodiments having integration voids, these may be employed to act as anchoring or positioning elements in relation to one or more segments or portions of the large structure. This aspect of the invention is particularly useful when the large structure to be stabilized, such as one or more of buildings, building foundations, roadways, runways, parking lots, dams, levees, embankments, waste containment facilities and other large structures comprises one or more of sand, soil, natural aggregates, synthetic aggregates, synthetic geonets and synthetic geocomposites.

Advantageously, geostabilizers of the invention are constructed and arranged such that one or more portions of the large structure are stabilized in accordance with specified engineering parameters and those parameters are chosen with respect to the combination of the geostabilizer with one or more of sand, soil, natural aggregates, synthetic aggregates, and synthetic geocomposites in relation to the one or more portions of the geo-related structure. Preferably, geostabilizers of the invention are constructed and arranged such that, when they are under load in relation to at least a portion of the large structure, retain at least 80%, and more preferably 90%, of their pre-load thickness.

In an additional aspect, geostabilizers of the invention are constructed and arranged such that the one or more portions of the large structure are stabilized in accordance with at least one pre-specified engineering parameter, for example, selected from the group of parameters including the CBR, frictional characteristics, resistance to flow, porosity, permeability, rigidity, resistance to heat transfer or other insulation index, density, soil cohesiveness, compactability, permeability to the flow of gases or liquids, and resistance to compression. In one preferred embodiment, the specified or pre-specified engineering parameter is the CBR test and the geostabilizer is constructed and arranged with respect to the subgrade such that the CBR values increase from at least 3% to at least 50%.

### BRIEF DESCRIPTION OF THE DRAWINGS

FIG. 1(a) is an oblique view of a one preferred embodiment of a wide sheet geostabilizer according to the invention. FIG. 1(b) is an oblique view of an embodiment of a wide sheet geostabilizer as in FIG. 1(a) and being provided with a plurality of perforations.

FIG. 2 is an oblique view of one preferred embodiment of a 5-layered synthetic strip sheet laminate according to the invention, the laminate being provided with square perforations.

FIG. 3 is an oblique view of a one preferred embodiment of a 5-layered tire strip sheet laminate according to the invention, wherein the strips in some layers are provided with beveled edges that form drainage channels.

FIG. 4 is an oblique view of a capped annulus formed of synthetic strips bonded together, the annulus being provided with a perforate end cap.

FIG. 5 is an oblique view of an annulus formed of tire strips bonded together, the annulus being provided with large diameter perforations and apertures.

FIG. 6 is an oblique view of a 2-layered synthetic strip sheet structure being provided with numerous small perforations.

FIG. 7 is an oblique view of a one preferred embodiment of a 3-layered tire strip according to the invention, the strip being provided with perforations suitable for both anchoring and drainage purposes.

### DETAILED DESCRIPTION OF THE INVENTION

The invention may be understood both with respect to the textual description provided herein and also with respect to the accompanying figures, which are exemplary only and show only a few of the many permutations of embodiments of the present geostabilizers.

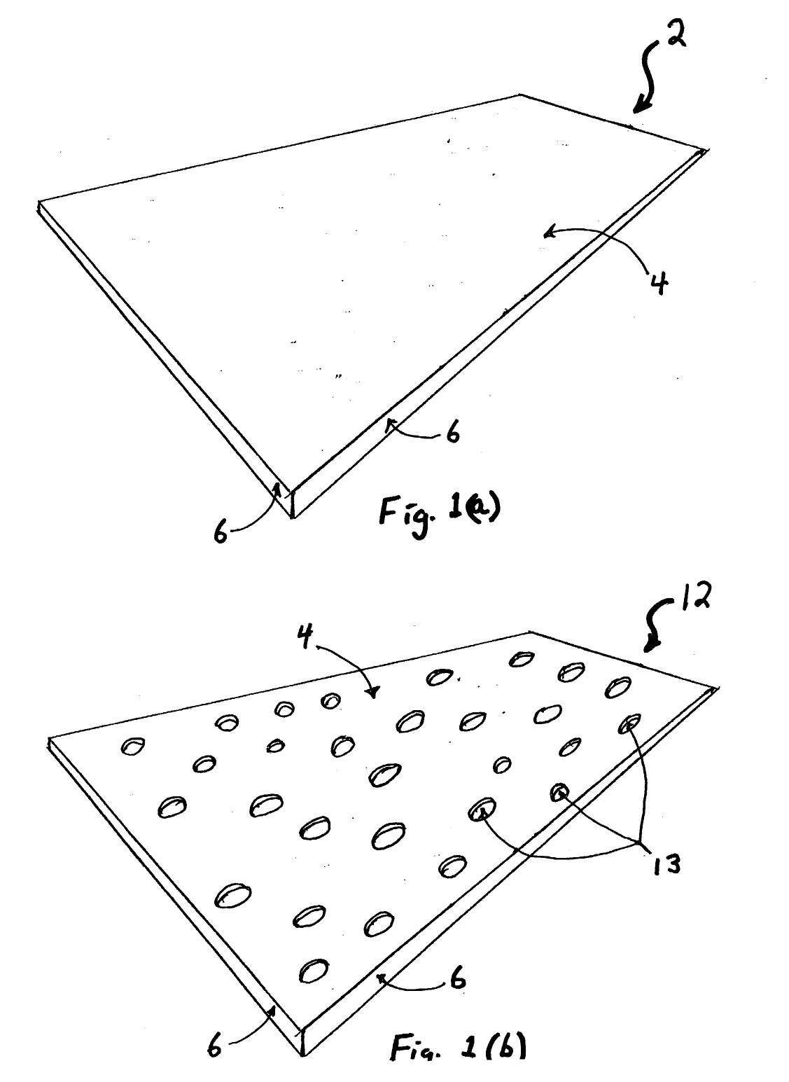

FIG. 1(a) is an oblique view of one preferred embodiment of wide sheet geostabilizer 2 according to the invention. Top surface 4 of substantially planar sheet geostabilizer 2, extends to geostabilizer margins 6. Geostabilizer 2, which can be formed of, in or into one piece, for example, by the extrusion or lamination of synthetic materials such as those disclosed herein, can be made in any suitable widths or lengths depending upon the nature of the installation into which it will be positioned. Many stabilizers according to the invention can be provided in roll form for the ease of transportation and storage.

FIG. 1(b) is an oblique view of an embodiment of a wide sheet geostabilizer 12 similar to geostabilizer 2 shown in FIG. 1(a). With reference to FIG. 1(b), geostabilizer 12 is provided with a plurality of perforations 13 which extend completely through geostabilizer 12. Top surface 4 of sheet geostabilizer 12 extends to geostabilizer margins 6. Geostabilizer 12, which can be formed of, in or into one piece, for example, by the extrusion or lamination of synthetic materials such as those disclosed herein, can be made in any suitable widths or lengths depending upon the nature of the installation into which it will be positioned. Perforations 13 of geostabilizer 12 can be provided in uniform or non-uniform sizes, and can be arrayed randomly or in one or more patterns. Furthermore, perforations 13 may be constructed and arranged to perform multiple functions such as those of drainage and anchoring.

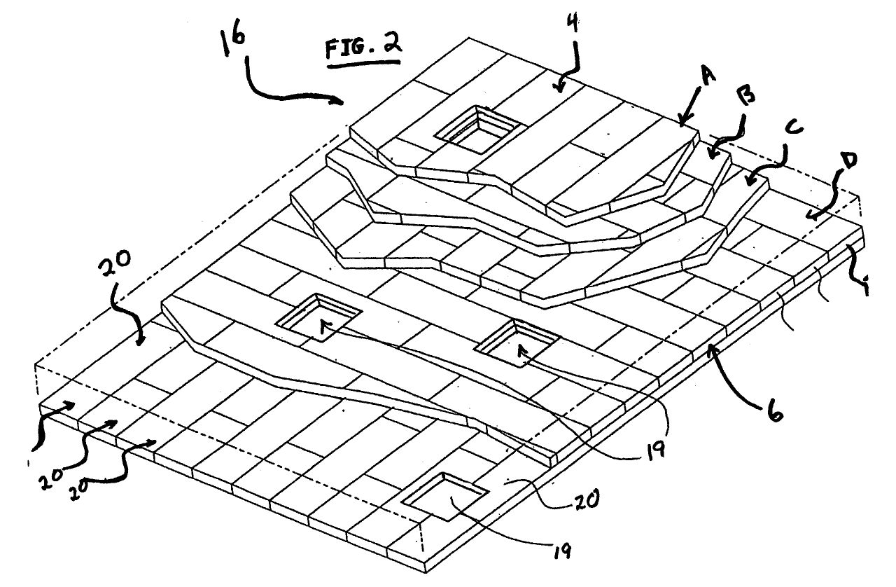

FIG. 2 is an oblique view of one preferred embodiment of a 5-layered synthetic strip sheet geostabilizer according to the invention, the laminated geostabilizer 16 being provided with square perforations. With reference to FIG. 2, laminated sheet geostabilizer 16 is provided with a plurality of square voids 19 which extend completely through geo-stabilizer 16. Top surface 4 of sheet geostabilizer 16 extends to geostabilizer margins 6. Geostabilizer 16 includes layers A, B, C, D, and E each of which is formed of a plurality of tire strips 20. Methods for adhering tire strips 20 and layers A, B, C, D and E into laminated geostabilizer are numerous and can be chosen with respect to the relative stiffness or flexural characteristics desired in geostabilizer 16.

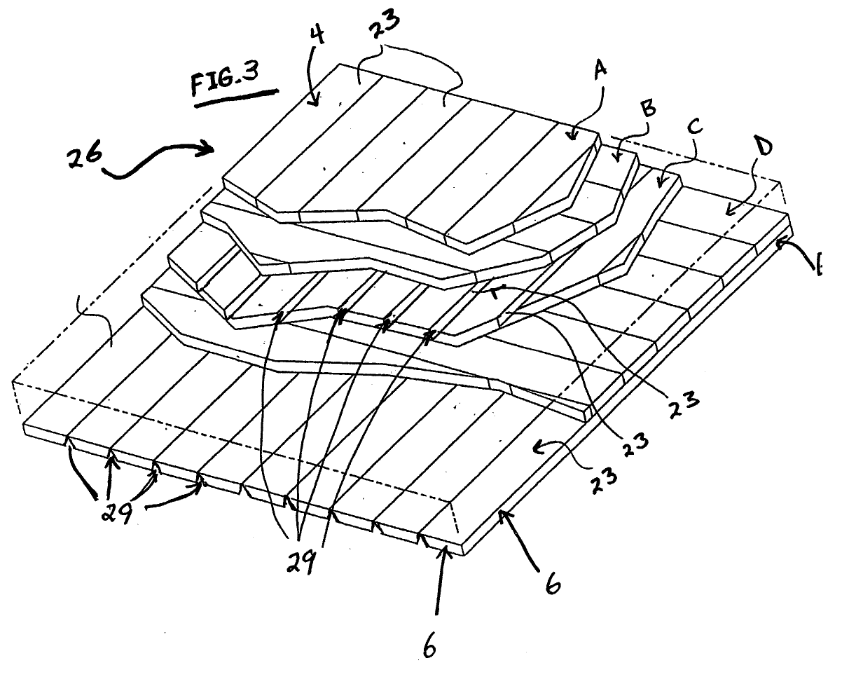

FIG. 3 is an oblique view of one preferred embodiment of a 5-layered tire strip sheet laminate according to the invention, wherein the strips in some layers are provided with beveled edges that form drainage channels. With reference to FIG. 3, laminated sheet geostabilizer 26 is provided with a plurality of drainage grooves 29 which extend completely through geo-stabilizer 26. Top surface 4 of sheet geostabilizer 26 extends to geostabilizer margins 6. Geostabilizer 26 includes layers A, B, C, D, and E each of which is formed of a plurality of tire strips 23 and beveled tire strips 23. Methods for adhering tire strips 23 and layers A, B, C, D and E into laminated geostabilizer 26 are numerous and can be chosen with respect to the relative stiffness or flexural characteristics desired in geostabilizer 26. Advantageously, geostabilizer 26 can include a plurality of beveled tire strips 23 such that the plurality of drainage grooves 29 are formed by the adjacency of beveled tire strips 23 to neighboring tire strips.

FIG. 4 is an oblique view of capped annulus 30 formed of synthetic strips bonded together, the annulus being provided with a perforate end cap. With reference to FIG. 4, annulus 30 is formed from a synthetic material such as recycled plastics or tire portions that have been processed into a plurality of strips 32 which form layers G, H, I and J of capped annulus 30. Annulus 30 is provided with end cap 36 which is provided with a plurality of apertures 33. Annulus 30 may be positioned in any manner in order to obtain its best effects. In accordance with one aspect of the invention, annulus 30 may be position with perforated end cap 36 downward and filled with aggregate (not shown). Thus positioned and filled with aggregate, annulus 30 will withstand great compressive forces and can function as a sump or other component of a drainage system.

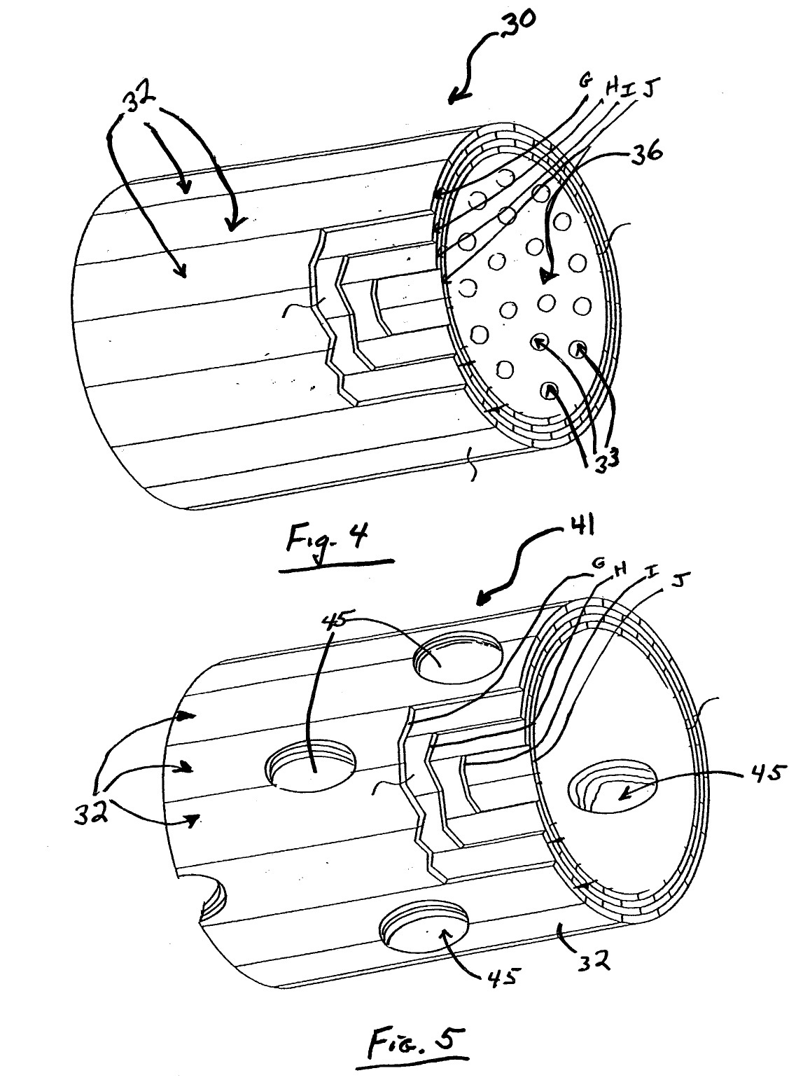

FIG. 5 is an oblique view of a tube formed of tire strips bonded together, the tube being provided with large diameter perforations or apertures. With reference to FIG. 5, tube 41 is formed from a synthetic material such as recycled plastics or tire portions that have been processed into a plurality of strips 32 which form layers G, H, I and J of perforated tube 41. Tube 41 is provided with a plurality of apertures 45 which can be disposed randomly or in one or more patterns. Tube 41 may be positioned in any relation to a large structure in order to obtain its best effects. In accordance with one aspect of the invention, tube 41 may be positioned horizontally, that is, with its longitudinal axis approximately horizontal or on a desired slope to function as a drainage tube. In another variation, tube 41 may be filled with aggregate (not shown). Thus positioned and filled with aggregate, tube 41 will withstand great compressive forces and can function as a sump or other component of a drainage system. As with other embodiments of the invention, apertures 45, or similar perforations can be of circular, elliptical or polygonal cross-section, and can be distributed evenly or unevenly over the tube to attain the desired drainage and compressibility characteristics.

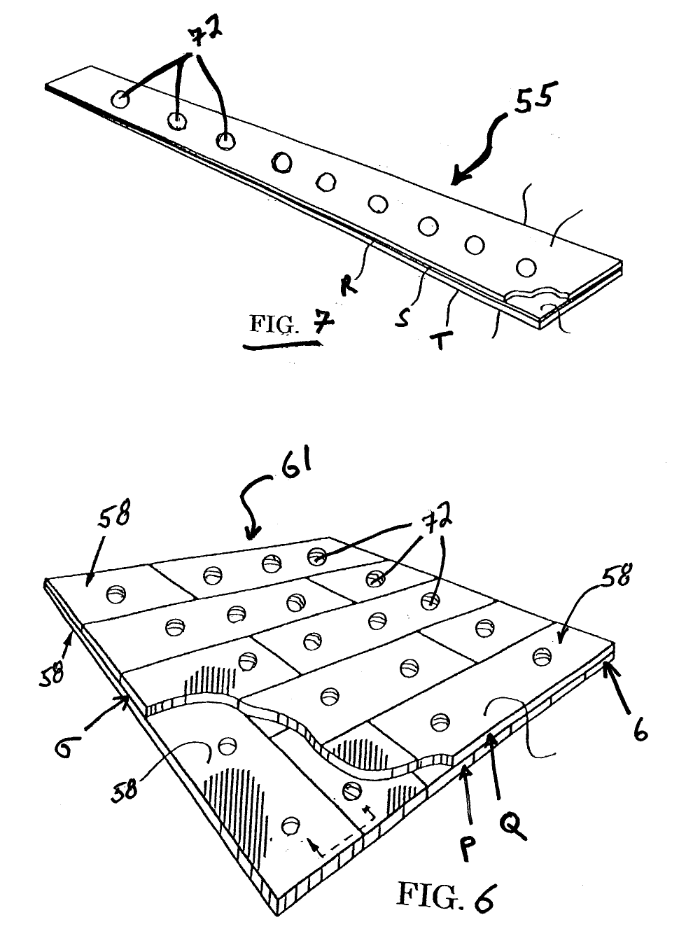

FIG. 6 is an oblique view of a 2-layered synthetic sheet structure being provided with numerous small perforations. With reference to FIG. 6, two-layered sheet laminate 61 is provided with a plurality of perforations 72 suitable for both anchoring and drainage purposes or for aligning with the perforations of another drainage or support element. Lower layer P and upper layer Q of laminate 61 are formed from a plurality of synthetic strips 58 which are arrayed parallel to one another within each layer and approximately perpendicular to one another with respect to the adjacent layers.

FIG. 7 is an oblique view of a one preferred embodiment of a 3-layered synthetic strip according to the invention, the strip being provided with perforations suitable for anchoring and drainage purposes and for connecting the strip to other drainage components. With reference to FIG. 7, three-layered laminated strip 55 is provided with a plurality of perforations 72 suitable for both anchoring and drainage purposes or for aligning with the perforations of another drainage or support element such as that shown in FIG. 6. Layers R, S and T of laminated strip 55 may be formed of strips that are parallel to one another in the respective layers or angled with respect to one another, such as the approximately perpendicular alignment of the strips forming the laminate of FIG. 6. The relative stiffness of strip 55 can be determined by, for example, the method by which layers R, S and T are attached to one another.

A significant aspect of the present invention is that it improves the performance of a particular subgrade with respect to the standardized ways of measuring such performance. As a result of such improvement in performance, the soil and aggregate layers for a given section of a large structure, such as a roadway, runway or parking lot, can be formed with less material, thereby saving time, and transportation and material costs.

Moreover, by interconnecting the various portions of the present invention such that the various interconnecting TSA's provide sufficient dimensional strength, the necessity of complex and expensive earthen-engineered foundation systems for roads and other large structures is diminished. Of course, as one of skill in the art will recognize, the present invention may also be used to divert geologic fluids to designated discharge points within or around the structure.

The strips of synthetic material can be bonded to one another by any means or methods that provide the desired bond strength, and enable formation of a sheet, lattice or gridwork of desired dimensions and shape. For example, bonding of the strips to one another can be achieved by means of one or more from the group consisting of adhesives, compression, heat welding, electron beam welding, sonic welding, solvent welding, mechanical connectors, weaving, laminating, or utilizing one or more fabric, net or grid to inhibit lateral movement of adjacent strips, sheets or panels.

Individual strips can be joined to one another so that they comprise joints that are impermeable to solids or fluids. In other embodiments, the strips are bonded to one another such that gaps exist between them to thereby render the structure permeable to fluids and gases, and to solids of a particular size range. In embodiments where succeeding layers of sheets or strips are oriented such that they cross the strips of an adjacent layer, the polygonal perforations formed by the intersections can be sized in accordance with the intended aggregates with which they will be used.

In yet another embodiment, the enclosure such as an annulus may comprise at least two ends that are substantially solid, the two ends being disposed substantially opposite one another, and wherein each of the two ends is provided with apertures suitable for the transmission of fluids to thereby provide a drainage structure. Lattice or grid-shaped geostabilizers of the invention can be used in combination with, or as a full or partial substitute for conventional non-uniform construction soils or bound uniform gradations of construction soils. Moreover, gridworks or lattices can be provided in two-dimensional or three-dimensional stabilized structures of connected synthetic strips, or laminations of such strips. The gridworks or lattices preferably have voids of sufficient dimension to permit desired particulate aggregates of, for example, stone, concrete, tire particles, or plastic to be installed or provided therein. The relative positions of the particles of aggregate can be fixed or not fixed in relation to one another depending upon the particular use to which the stabilized structure is directed, and depending upon the nature of the combination of aggregates that is used.

When desirable, the respective positions to one another of the sheets, strips and aggregate can be fixed in relation to one another by bonding, mechanical connections, or fabricating in a manner that provides connection strength between sheets, panels, gridworks or lattices, such that adjacent strips maintain substantially the same relative orientation to one another after long exposure to construction loadings.

Embodiments of the present methods and structures are provided with defined engineering properties that can be maintained for desired lengths of time. This makes them useful for replacing or complementing conventional soils and aggregates of stone, sand and soils that are designed and engineered for structural stability on construction sites. Thus, the present invention can have myriad embodiments, configurations and properties depending upon the exact engineering construction environment in which a particular embodiment will be used. Whether provided as large solid or perforated sheets, or as strips adhered together into grids, lattices or mats, or positioned as loose strips, the present geostabilizer systems can form part of a greater subsurface system that provides effective reinforcement of, and separation of, conventional construction and foundation materials.

What is claimed is:

1. A method for reducing the quantity of earthen uniform and non-uniform gradations of structural fill needed to support a large structure, comprising the steps of:
A) processing synthetic materials into sheets or strips to form at least one geostabilizer of known dimensions, and
B) positioning said geostabilizer in relation to at least a portion of the ubgrade of said large structure such that the quantity of said uniform and non-uniform gradations of structural fill necessary to support said large structure is reduced.

2. The method of claim 1, wherein said large structure is one or more from the group consisting of buildings, building foundations, roadways, runways, parking lots, dams, levees, embankments, waste containment facilities and other large structures.

3. The method of claim 1, wherein said synthetic materials are one or more selected from the group consisting of new, recycled or used vehicle tires, and new, used or recycled plastic polymers.

4. The method of claim 1, wherein said processing comprises the further step of
Ai) sorting said sheets or strips into categories based upon their physical properties.

5. The method of claim 4, wherein said physical properties of said sheets or strips are selected according to the parameters of use and installation environment of said geostabilizer and said large structure.

6. The method of claim 4, wherein said physical properties of said sheets or strips are one or more selected from the group consisting of
shape, size, color, compressive strength, flexibility, beam strength, frictional characteristics, resistance to flow, porosity, permeability, rigidity, resistance to heat transfer or other insulation index, chemical compatibility, density, elasticity, compactability, compressibility, permeability to the flow of gases or liquids, tensile strength, resistance to chemical degradation, resistance to degradation by microbes, resistance to degradation by visible or non-visible light, resistance to degradation by nuclear radiation, and resistance to compression.

7. The method of claim 1, wherein the synthetic materials are processed into a geostabilizer comprising the shape of one or more from the group consisting of sheets, strips, bars, discs, toruses, lattices, grids, woven grids, sheets, laminates of sheets or strips, annuli, beams, columns, spirals and combinations thereof.

8. The method of claim 1, wherein said geostabilizer comprises one or more voids in the nature of one or more of perforations, apertures, slots, grooves, channels, corrugations, convolutions, recesses, sumps, notches, hollows, passages, ducts and combinations thereof.

9. The method of claim 8, wherein said one or more voids are constructed and arranged to function as one or more of inter-strip or inter-sheet connectors, drainage passageways, sumps, connection holes for anchors, connection holes for inter-strip connectors and integration voids for retaining natural fill materials such as stone, sand, soil and aggregate mixtures.

10. The method of claim 1, wherein said one or more portions of said large structure comprise one or more of sand, soil, natural aggregates, synthetic aggregates, synthetic geonets and synthetic geocomposites.

11. The method of claim 1, wherein said positioning of said geostabilizer in relation to said at least a portion of said subgrade is performed during the construction or assembling of said one or more portions of said large structure.

12. The method of claim 1, wherein said geostabilizer is positioned, in relation to a roadway, runway or building foundation, in one or more positions from the group consisting of
above or below the subgrade, between earthen or aggregate layers, above or below earthen or aggregate layers, above bedrock, or adjacent to a concrete foundation of said roadway, runway or foundation.

13. The method of claim 1, wherein said geostabilizer is constructed and arranged such that said one or more portions of said large structure are stabilized in accordance with at least one pre-specified engineering parameter.

14. The method of claim 13, wherein said at least one pre-specified engineering parameter is one or more from the group consisting of the CBR, frictional characteristics, resistance to flow, porosity, permeability, rigidity, resistance to heat transfer or other insulation index, density, soil cohesiveness, compactability, permeability to the flow of gases or liquids, and resistance to compression.

15. The method of claim 14, wherein said pre-specified engineering parameter is the CBR test and said geostabilizer is constructed and arranged with respect to said subgrade such that the CBR values increase at least 3%.

16. The method of claim 14, wherein said pre-specified engineering parameter is the CBR test and said geostabilizer is constructed and arranged with respect to said subgrade such that the CBR values increase at least 6%.

17. The method of claim 14, wherein said pre-specified engineering parameter is the CBR test and said geostabilizer is constructed and arranged with respect to said subgrade such that the CBR values increase at least 9%.

18. The method of claim 14, wherein said pre-specified engineering parameter is the CBR test and said geostabilizer is constructed and arranged with respect to said subgrade such that the CBR values increase at least 15% or at least 25%.

19. The method of claim 1, wherein said geostabilizer, when under load, retains at least 90% of its pre-load thickness.

20. The method of claim 1, wherein said geostabilizer, when under load, retains at least 80% of its pre-load thickness.

21. A geostabilizer comprising one or more sheets or strips formed from synthetic materials wherein,
i) said sheets or strips are provided in known dimensions and categories based upon their physical properties, and
ii) said physical properties are selected according to the types of use and installation of said sheets or strips in relation to said large structure such that
iii) positioning said geostabilizer in relation to at least a portion of the subgrade of said large structure results in a reduction of the quantity of uniform and non-uniform gradations of structural fill necessary to support said large structure.

22. The geostabilizer of claim 21, wherein said physical properties of said sheets or strips are one or more selected from the group consisting of
shape, size, color, compressive strength, flexibility, beam strength, frictional characteristics, resistance to flow, porosity, permeability, rigidity, resistance to heat transfer or other insulation index, chemical compatibility, density, elasticity, compactability, permeability to the flow of gases or liquids, tensile strength, resistance to chemical degradation, resistance to degradation by microbes, resistance to degradation by visible or non-visible light, resistance to degradation by nuclear radiation, and resistance to compression.

23. The geostabilizer of claim 21, wherein said synthetic materials are one or more selected from the group consisting of vehicle tires and new or recycled plastic polymers.

24. The geostabilizer of claim 21, in the form of one or more from the group consisting of sheets, strips, bars, discs, toruses, lattices, grids, woven grids, sheets, laminates of sheets or strips, annuli, beams, columns, spirals and combinations thereof.

25. The geostabilizer claim 21, further comprising one or more voids in the nature of perforations, apertures, slots, grooves, channels, corrugations, convolutions, recesses, sumps, notches, hollows, passages, ducts and combinations thereof.

26. The geostabilizer structure of claim 25, wherein said one or more voids are constructed and arranged to function as one or more of
inter-strip connectors, drainage passageways, sumps, connection holes for anchors, connection holes for inter-strip connectors and voids for retaining natural fill materials such as stone, sand, soil and aggregate mixtures.

27. The geostabilizer of claim 21, in combination with one or more portions of said large structure, wherein said large structure is one or more from the group consisting of buildings, building foundations, roadways, runways, parking lots, dams, levees, embankments, waste containment facilities and other large structures.

28. The geostabilizer of claim 27, wherein said one or more portions of said geo-related structure comprise one or more of sand, soil, natural aggregates, synthetic aggregates, and synthetic geocomposites.

29. The geostabilizer of claim 27, wherein said geostabilizer, when under load, retains at least 90% of its pre-load thickness.

30. The geostabilizer of claim 27, wherein said geostabilizer, when under load, retains at least 80% of its pre-load thickness.

31. The geostabilizer of claim 27, wherein said geostabilizer is constructed and arranged such that said one or more portions of said large structure are stabilized in accordance with specified engineering parameters.

32. The geostabilizer of claim 31, wherein said specified engineering parameters are chosen with respect to the combination of said geostabilizer with one or more of sand, soil, natural aggregates, synthetic aggregates, and synthetic geocomposites in relation to said one or more portions of said geo-related structure.

33. The geostabilizer of claim 21, wherein said geostabilizer is constructed and arranged such that said one or more portions of said large structure are stabilized in accordance with at least one pre-specified engineering parameter chosen form the group consisting of the CBR, frictional characteristics, resistance to flow, porosity, permeability, rigidity, resistance to heat transfer or other insulation index, density, soil cohesiveness, compactability, permeability to the flow of gases or liquids, and resistance to compression.

34. The geostabilizer of claim 31, wherein said pre-specified engineering parameter is the CBR test and said geostabilizer is constructed and arranged with respect to said subgrade such that the CBR values increase from at least 3% to at least 50%.
